(19) United States
(12) Patent Application Publication
(10) Pub. No.: US 2025/0356184 A1
(43) Pub. Date: Nov. 20, 2025

(54) POSITIONAL EMBEDDING GENERATION FOR MACHINE LEARNING MODELS

(71) Applicant: QUALCOMM Incorporated, San Diego, CA (US)

(72) Inventors: Junyoung PARK, Palo Alto, CA (US); Mukul GAGRANI, Milpitas, CA (US); Raghavv GOEL, San Diego, CA (US); Wonseok JEON, San Diego, CA (US); Mingu LEE, San Diego, CA (US); Christopher LOTT, San Diego, CA (US)

(21) Appl. No.: 18/667,920

(22) Filed: May 17, 2024

(51) Int. Cl. G06N 3/08

(52) U.S. Cl. CPC G06N 3/08

(57) ABSTRACT

Certain aspects of the present disclosure provide techniques and apparatus for improved machine learning. In an example method, a sequence of tokens is accessed as input to an attention operation. For a first token, an attention output is generated based on a window of tokens relative to the first token, comprising generating a first positional embedding for an influential token, generating a second positional embedding for the first token, and generating the attention output based on the first and second positional embeddings. For a second token, an attention output is generated based on a window of tokens relative to the second token, where the second window of tokens includes the first token, comprising generating a third positional embedding for the influential token, generating a fourth positional embedding for the second token, and generating the attention output based on the second, third, and fourth positional embeddings.

### INTRODUCTION

Aspects of the present disclosure relate to machine learning.

A wide variety of machine learning model architectures have been developed to perform a variety of tasks, including generation of data such as text, images, video, audio, and the like, entity classification or detection, value or probability regression, and many others. Many modern model architectures, such as transformer-based models, rely on attention operations to process input. For example, many large language models (LLMs) use transformer-based attention. Attention mechanisms are often used to force the model to focus attention on specific portions of data based on learned parameters. Although attention operations can substantially improve model performance (e.g., accuracy of the model output), attention operations are also computationally expensive.

For example, transformer-based attention operations that use query-key-value (QKV) approaches generally have quadratic computational complexity (where the attention mechanism has O(n²) complexity for input sequence length n, due to giving attention with respect to all tokens in the sequence). Further, models trained with a given context length (e.g., a defined maximum number of tokens for which attention is computed) may exhibit low performance for context lengths that differ from the given length (e.g., due to a significant increase in mode perplexity, which may be caused by out-of-distribution (OOD) positional embeddings for the longer context lengths).

### BRIEF SUMMARY

Certain aspects of the present disclosure provide a processor-implemented method, comprising: accessing a sequence of tokens as input to an attention operation of a machine learning model; generating, for a first token of the sequence of tokens, a first attention output based on a first window of tokens relative to the first token, comprising: generating a first positional embedding for a first influential token of a set of influential tokens in the sequence of tokens; generating a second positional embedding for the first token; and generating the first attention output based on the first and second positional embeddings; and generating, for a second token of the sequence of tokens, a second attention output based on a second window of tokens relative to the second token, wherein the second window of tokens includes the first token, comprising: generating a third positional embedding for the first influential token; generating a fourth positional embedding for the second token; and generating the second attention output based on the second, third, and fourth positional embeddings.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow for long-context generation in machine learning models, according to some aspects of the present disclosure.

FIGS. 2A and 2B depict example workflows to generate positional embeddings for long-context generation in machine learning models, according to some aspects of the present disclosure.

FIG. 3 is a flow diagram depicting an example method for improved attention operations in machine learning models, according to some aspects of the present disclosure.

FIG. 4 is a flow diagram depicting an example method for positional embedding generation for machine learning models, according to some aspects of the present disclosure.

FIG. 5 is a flow diagram depicting an example method for positional embedding generation, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning.

As discussed above, attention operations often result in substantial computational expense during runtime use. For example, given a sequence of tokens, some conventional attention operations compute positional embeddings (PEs) (sometimes referred to as position embeddings, position encodings, and/or positional encodings) twice for each token (once for the current query, and once for the current key). As used herein, a “token” is a base unit of data (e.g., the smallest or most granular unit that the model operates on), and may include individual characters (e.g., letters, or numbers, or symbols), multiple characters, words, phrases, and the like. PEs are generally used to encode the position of a given token relative to another token in a sequence of tokens (e.g., the attention value for a first token may be determined based on PEs, relative to the first token, for one or more other tokens in the sequence). Some recent attempts to mitigate these concerns have included window attention, which involves caching portions of the attention data (e.g., the keys and values, sometimes referred to as KV caching) for tokens, and re-computing PEs at each step (e.g., for each token in the window) to prevent out-of-distribution (OOD) PEs during runtime. For example, a window attention approach may compute 1 PE for the current query and W PEs for the W keys (e.g., the number of tokens) in the window. As used herein, a “window” generally refers to a defined set of tokens (which may include a given or index token, along with zero or more tokens near to the given token and/or zero or more defined influential tokens).

Some recent approaches involve use of “sink” tokens, also referred to in some cases as “influential” tokens, to improve model accuracy. It has been observed that the first few tokens in a sequence (e.g., the initial tokens at the beginning of the sequence) are often provided relatively high attention, as compared to subsequent tokens. Therefore, a window attention approach that removes these initial tokens from consideration for subsequent tokens can dramatically reduce model performance. Some approaches to mitigate these concerns include the use of influential tokens, where a defined number of initial tokens (at the start of the token sequence) are included in the window regardless of which token is currently being processed. For example, for the m-th token, the window may include the first s tokens in the sequence (the sink or influential tokens) as well as l tokens leading up to the m-th token in the sequence (referred to in some aspects as “recent” tokens). However, due to the positional index reordering caused by such approaches, the PEs of all tokens in the window are recomputed at each step, which causes substantial computational expense.

Aspects of the present disclosure utilize selective or dynamic re-computation and re-use of PEs from prior tokens in order to substantially improve the efficiency (e.g., reduce the computational expense) of attention operations in machine learning models. As used herein, an “attention operation” generally refers to a technique for prioritizing or evaluating a set of related information or data when generating output for a given unit of data. For example, the output for a given token may be determined based in part on the values of other tokens in the input. Similarly, “attention output” may generally refer to the output of such attention operations. In some aspects, one or more relative positional embedding operations may be used to generate the PEs in the model. In some aspects, relative positional embeddings whose dot product is invariant to translation of the indices is used, such as rotary positional embeddings (RoPEs). Use of such relative positional embeddings can enable selective re-use of previously generated PEs in some aspects, as discussed in more detail below. Generally, a “positional embedding” for a given token represents the position of the given token (relative to an overall sequence, or relative to another specific token).

In some aspects, for example, the system may determine to re-compute PEs of keys for either influential tokens (e.g., sink tokens) or recent tokens in the window, while re-using PEs of the other set of tokens, to reduce the number of PE computations. That is, the system may re-compute the PEs for the influential tokens while re-using previously generated PEs for the recent tokens, or vice versa, to reduce the total number of PEs that are generated per token. This can substantially reduce the computational complexity of the attention operations.

Advantageously, the techniques described herein enable machine learning models (e.g., LLMs) to maintain low perplexity even for long contexts (e.g., windows or sequences that may be substantially longer than those used during training) without involving or relying on any re-training of the models themselves. Further, using translation-invariant relative positional embedding computations, the model output may still match the outputs of conventional approaches while expending substantially reduced computational resources (e.g., reduced memory accesses and/or footprint, reduced processing time, reduced power consumption, reduced heat generation, and the like).

### Example Workflow for Long-Context Generation in Machine Learning Models

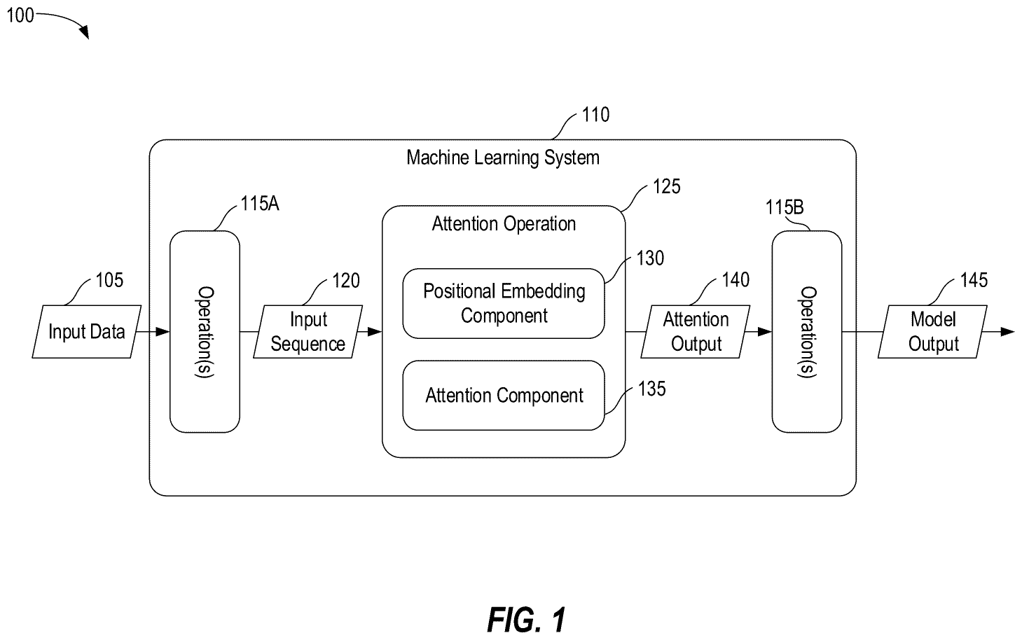

FIG. 1 depicts an example workflow 100 for long-context generation in machine learning models, according to some aspects of the present disclosure.

In the illustrated example, input data 105 is processed by a machine learning system 110 to generate model output 145. The machine learning system 110 is generally representative of any computing system that uses and/or trains machine learning models to generate output, and may be implemented using hardware, software, or a combination of hardware and software. Generally, the particular model architecture used by the machine learning system 110 may vary depending on the particular implementation. In some aspects, the machine learning model comprises or uses one or more attention operations (e.g., an attention operation 125) to process data. For example, the machine learning system 110 may use a transformer-based model to generate self-attention at one or more points in the model. In some aspects, the machine learning system 110 implements a language model architecture (e.g., a large language model (LLM)) or another generative artificial intelligence (AI) model architecture.

In the illustrated example, the machine learning system 110 uses one or more operations 115A prior to the attention operation 125, as well as one or more operations 115B after the attention operation 125. Generally, the operations 115A and 115B may represent any machine learning operation used to process data, such as feedforward components (e.g., one or more neural network layers), activation components (e.g., to apply activation functions to data), and the like. Although the illustrated example depicts operations 115A and 115B before and after the attention operation 125, in some aspects, one or more of the depicted operations 115 may be absent. Further, although a single attention operation 125 is depicted for conceptual clarity, in some aspects, the machine learning system 110 may use any number of attention operations 125 at any point in the model data flow.

The input sequence 120 is generally representative of any ordered sequence of tokens, where a token represents the individual units or elements that are being processed. For example, in the case of language models, the tokens may represent words or phrases (and/or portions thereof). As another example, for image processing, the tokens may represent image patches. Generally, the tokens in the input sequence 120 may comprise the input data 105 itself (e.g., if no operations 115A are used prior to the attention operation 125) or may correspond to the results of various operations being applied to the tokens in the input data 105. For example, the input sequence 120 may be a sequence of tensors generated based on applying feature extraction or other operations to the input data 105.

In the illustrated example, the attention operation 125 is generally used to provide self-attention for the model. That is, the attention operation 125 receives the input sequence 120 (e.g., a sequence of tokens) generated by the operation(s) 115A and generates attention output 140 (e.g., attention values for each token in the input sequence 120). In some aspects, the attention operation 125 generates an attention output value for each given token in the input sequence 120 based on one or more other tokens in the sequence. For example, the attention operation 125 may use a QKV attention mechanism, where the attention value for a given token is generated based on the value(s) of one or more other tokens in the sequence.

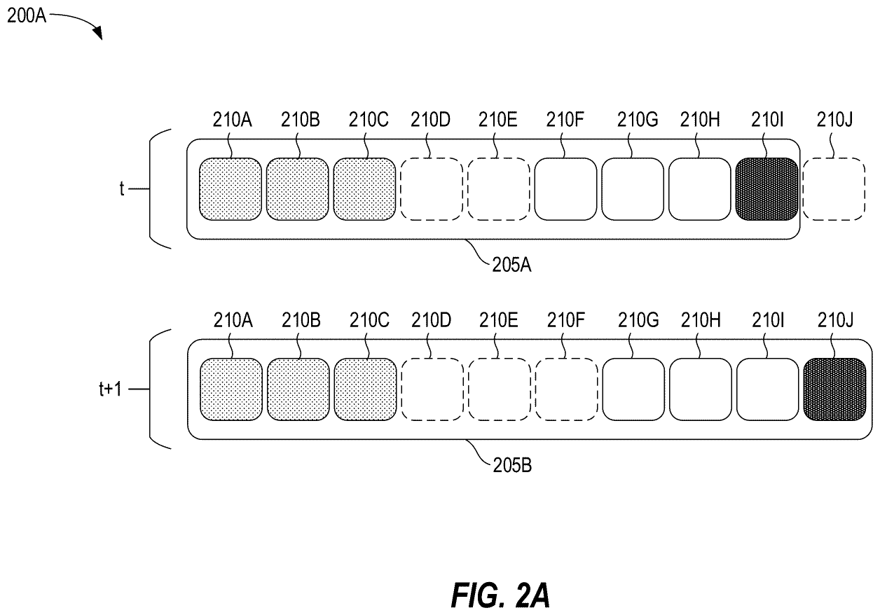

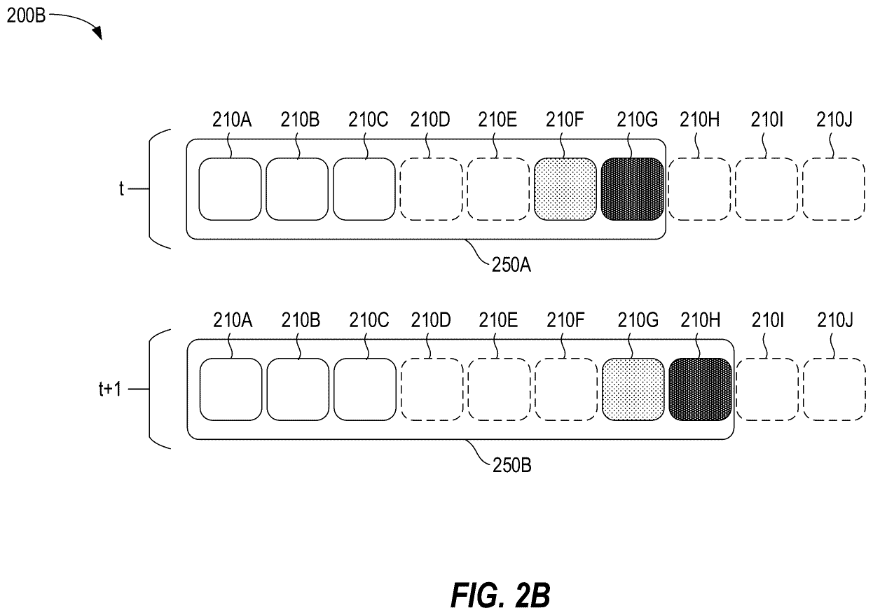

For example, as discussed above, the attention operation 125 may compute the attention for a given token with respect to all other tokens in the sequence, all prior tokens in the sequence, or a subset of tokens in the sequence (e.g., using window attention). In some aspects, as discussed above, the attention operation 125 may compute the attention for a given token based on a set of influential tokens (e.g., the first N tokens in the sequence) and a set of recent tokens (e.g., the M tokens leading up to the given token in the sequence), as discussed in more detail below with reference to FIGS. 2A and 2B.

In the illustrated example, the attention operation 125 uses positional embeddings (PEs) to encode the relative positions of the tokens when computing attention output 140. The PEs generally encode or represent the position of each token relative to the given token for which attention is being computed. That is, the attention output for a given token may be generated based in part on PEs for each other token in the window of tokens. These PEs enable the model to better understand the relationships among tokens.

As discussed above, in some conventional approaches, the system computes new PEs for all tokens in the window at each time step. That is, for each given token, the system may identify the tokens in the window with respect to the given token and re-compute the PEs of these tokens with respect to the given token. The system can then compute the attention for the given token. However, as discussed above, this frequent re-computation of PEs can introduce substantial computational expense.

In the illustrated example, therefore, the attention operation 125 may selectively re-compute some PEs while re-using other PEs in order to substantially reduce the computational expense of the attention mechanism.

In the illustrated system, the attention operation 125 includes a positional embedding component 130 and an attention component 135. Although depicted as discrete components for conceptual clarity, the operations of the depicted components (and others not illustrated) may be combined or distributed across any number of components. Generally, the positional embedding component 130 is used to generate PEs and/or access previously generated PEs for tokens in the input sequence 120 to facilitate the attention process. For example, as discussed above, for each respective token in a given window (to generate attention for a given token), the positional embedding component 130 may either generate a PE for the respective token or access a previously generated PE for the respective token. The attention component 135 generates the attention value (e.g., a portion of the attention output 140) for the given token based on the PEs provided by the positional embedding component (e.g., using a QKV attention mechanism).

In some aspects, as discussed below in more detail, the positional embedding component 130 generates new PEs for each influential token in the window, while re-using previously generated PEs for each other token in the window. In some aspects, the positional embedding component 130 re-uses previously generated PEs for each influential token in the window, while generating new PEs for each other token in the window. In some aspects, the positional embedding component 130 determines which PEs to re-use based on the number of influential tokens and the number of recent tokens in the window. For example, if there are more influential tokens than recent tokens, the positional embedding component 130 may determine to generate new PEs for the recent tokens and re-use PEs for the influential tokens. If there are more recent tokens than influential tokens, the positional embedding component 130 may determine to generate new PEs for the influential tokens and re-use PEs for the recent tokens, as discussed in more detail below.

In the illustrated example, the attention output 140 may be optionally processed using one or more operations 115B to generate model output 145. Generally, as discussed above, the attention output 140 is a sequence of tokens (e.g., tensors) having attention value(s) generated by the attention operation 125. Generally, the particular content and format of the model output 145 and input data 105 may vary depending on the particular implementation and architecture. For example, the model output 145 may vary depending on the particular task which the machine learning system 110 performs.

For example, in some aspects, the input data 105 may comprise or correspond to natural language text (e.g., a query or chat prompt), and the model output 145 may include text (e.g., natural language text, computer code in one or more programming languages, and the like). In some aspects, the model output 145 may include (or may be used to generate) an output signal to control a machine (e.g., a computer). For example, the model output 145 may include programming instructions that can be executed to cause a computing system to perform a wide variety of actions.

Advantageously, by selectively re-using previously generated PEs for some tokens, the machine learning system 110 can substantially reduce the computational expense of generating the model output 145. For example, memory usage, number of processing cycles, power consumption, heat generation, and the like may all be reduced. Further, by using a relative positional embedding algorithm that exhibits translational invariance, the model output 145 may remain accurate (e.g., identical to the output generated by other approaches that re-generate all PEs, in some cases). Further, such selective re-use may enable dynamic or expanded context lengths (e.g., longer windows used to generate the attention) without relying on any re-training or refinement of the model itself. That is, the model may be trained using a first window length, and the machine learning system 110 may use a second (longer) context length without loss of performance.

### Example Workflows to Generate Positional Embeddings for Long-Context Generation in Machine Learning Models

FIGS. 2A and 2B depict example workflows 200 to generate positional embeddings for long-context generation in machine learning models, according to some aspects of the present disclosure. Specifically, FIG. 2A depicts a workflow 200A for re-using PEs for influential tokens while generating new PEs for recent tokens, while FIG. 2B depicts a workflow 200B for re-using PEs for recent tokens while generating new PEs for influential tokens. In some aspects, the workflows 200 are performed by a machine learning system, such as the machine learning system 110 of FIG. 1.

As illustrated in FIG. 2A, the input to the attention operation (e.g., 125 in FIG. 1) includes a sequence of tokens 210A-J (sometimes collectively referred to as tokens 210). As illustrated, the workflow 200A uses a window size of seven (e.g., seven tokens 210 are included in a window 205 when generating attention for each token) with three influential tokens 210A, 210B, and 210C. As discussed above, the influential tokens correspond to the first N tokens at the beginning of the sequence, where N is a fixed or static number (e.g., a hyperparameter). Similarly, the window size may be a fixed or static number (e.g., another hyperparameter). In some aspects, as discussed above, “recent” tokens correspond to those tokens in the window that immediately precede the given token for which attention is being computed (e.g., the M recent tokens). The number of recent tokens generally corresponds to the window size minus the number of influential tokens used. In some aspects, the term “recent token” includes the given token itself, while in others, the term “recent token” does not include the given token. In other examples, the workflow 200A uses a window of any size and with any number of influential tokens.

In the illustrated example, at a first time step (e.g., when generating attention for a first token, such as the token 210I, at time t), the window 205A includes the three influential tokens 210A, 210B, and 210C, as well as recent tokens 210F, 210G, and 210H, and the given token 210I itself. That is, the attention output for the token 210I is generated with respect to the tokens 210A, 210B, 210C, 210F, 210G, 210H, and 210I. In the illustrated example, tokens 210 illustrated with dashed lines (e.g., the tokens 210D, 210E, and 210J) are excluded tokens not included in the window 205A. That is, these excluded tokens are not considered when generating the attention for the token 210I.

In the illustrated workflow 200A, to generate the attention output for the token 210I (indicated by relatively heavy stippling), the machine learning system determines to generate a new PE for each influential token 210A, 210B, and 210C (as indicated by the relatively lighter stippling of these tokens), as well as a new PE for the token 210I (as this token has not yet been processed and there is no prior value which can be reused). As indicated by solid lines with no fill, the machine learning system determines to re-use the previously generated PEs for the recent tokens 210F, 210G, and 210H. For example, the PE for the token 210H may have been generated when generating attention for the token 210H, the PE for the token 210G may have been generated when generating attention for the token 210G, and so on. By selectively reusing these PEs, the machine learning system can substantially reduce computational expense of the attention operation.

As illustrated, at a second time step (at time t+1), the machine learning system then generates attention output for the next token (e.g., the token 210J). As illustrated, the size of the window 205B remains seven, and the machine learning system still uses three influential tokens (the tokens 210A, 210B, and 210C) as well as three recent tokens (the tokens 210G, 210H, and 210I), in addition to the token 210J. Here, the token 210I is used in the window (instead of the token 210F) because the token 210I is relatively more recent to the current token 210J. The tokens 210D, 210E, and 210F are excluded from the window 205B, as indicated by the dashed lines.

In the illustrated example, to generate the attention output for the token 210J, the machine learning system generates a PE for the token 210J (as a previously generated PE is not available), as well as generating new PEs for the influential tokens 210A, 210B, and 210C. The machine learning system determines to re-use the PEs generated previously for the recent tokens 210G, 210H, and 210I. For example, as discussed above, the PE for the token 210I was generated during the immediately prior time step (when computing attention for the token 210I), and so on.

In some aspects, the machine learning system determines to generate new PEs for the influential tokens 210A, 210B, and 210C at each time step based on comparing the number of influential tokens (e.g., the size of the set of influential tokens, which may be a hyperparameter) and the number of recent tokens (e.g., the size of the set of recent tokens, which may be defined based on subtracting the size of the set of influential tokens from the window size). Because the illustrated example includes a window size of seven and uses three influential tokens, there are four recent tokens for each given token. Therefore, the machine learning system may determine to generate new PEs for each influential token (three new PEs per time step) while re-using PEs for the recent tokens.

As illustrated in the example of workflow FIG. 2B, the input to the attention operation includes a sequence of tokens 210A-J. In the workflow 200B, a window size of five is used (e.g., five tokens 210 are included in a window 250 when generating attention for each token) with three influential tokens 210A, 210B, and 210C. In other examples, the workflow 200B uses a window of any size and with any number of influential tokens.

In the illustrated example, at a first time step (e.g., when generating attention for a first token, such as the token 210G at time t), the window 250A includes the three influential tokens 210A, 210B, and 210C, as well as recent token 210F, and the given token 210G itself. That is, the attention output for the token 210G is generated with respect to the tokens 210A, 210B, 210C, 210F, and 210G. In the illustrated example, the tokens 210 illustrated with dashed lines (e.g., the tokens 210D, 210E, 210H, 210I, and 210J) are excluded tokens, and thus not included in the window 250A. That is, these excluded tokens are not considered when generating the attention for the token 210G.

In the illustrated workflow 200B, to generate the attention output for the token 210G, the machine learning system determines to generate a new PE for the (only) recent token 210F as well as the token itself 210G (as indicated by the stippling of these tokens). As indicated by solid lines with no fill, the machine learning system determines to re-use the previously generated PEs for the influential tokens 210A, 210B, and 210C.

As illustrated, at a second time step (at time t+1), the machine learning system then generates attention output for the next token (e.g., the token 210H). As illustrated, the size of the window 250B remains five, and the machine learning system still uses three influential tokens (the tokens 210A, 210B, and 210C) as well as one recent token (the token 210G), in addition to the token 210H. The tokens 210D, 210E, 210F, 210I, and 210J are excluded from the window 250B.

In the illustrated example, to generate the attention output for the token 210H, the machine learning system generates a PE for the token 210H (as a previously generated PE is not available), as well as generating a new PE for the recent token 210G. The machine learning system determines to re-use the PEs generated previously for the influential tokens 210A, 210B, and 210C. For example, as discussed above, the PEs for the influential tokens may have been generated during prior time step(s).

In some aspects, the machine learning system determines to generate new PEs for the recent tokens at each time step based on comparing the number of influential tokens and the number of recent tokens, as discussed above. Because the illustrated example of FIG. 2B includes a window size of five and uses three influential tokens, there are two recent tokens for each given token (including the given token itself). Therefore, the machine learning system may determine to generate new PEs for each recent token (two new PEs per time step) while re-using PEs for the influential tokens.

In some aspects, the machine learning system dynamically determines whether to generate new PEs for the influential tokens or the recent tokens based on the size of each set. That is, when generating attention for a given token, the machine learning system may determine the number of recent tokens and the number of influential tokens, and determine which PEs to generate and which to re-use. This may be advantageous if the number of tokens may change. For example, in some aspects, while processing the first few tokens, the window may include relatively few recent tokens as compared to the number of influential tokens. Further into the sequence, the number of recent tokens may generally be larger than the number of influential tokens (e.g., because the number of influential tokens is generally a relatively small value).

In some aspects, rather than dynamically determining which set of PEs to generate, the machine learning system may use a static or fixed configuration (e.g., always regenerating influential PEs, always regenerating recent PEs, or determining which PEs to regenerate based on the current time step and/or which token is currently being processed).

### Example Method for Efficient Attention Operations in Machine Learning Models

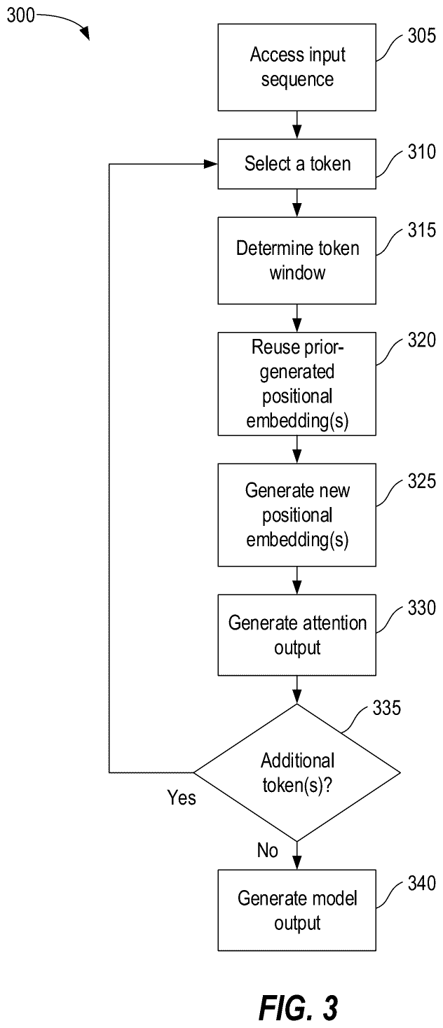

FIG. 3 is a flow diagram depicting an example method 300 for improved attention operations in machine learning models, according to some aspects of the present disclosure. In some aspects, the method 300 is performed by a machine learning system, such as the machine learning system 110 of FIG. 1 and/or the machine learning system discussed above with reference to FIG. 2.

At block 305, the machine learning system accesses a sequence of input tokens (e.g., the input sequence 120 of FIG. 1). As used herein, “accessing” data may generally include receiving, requesting, retrieving, generating, collecting, obtaining, or otherwise gaining access to the data. In some aspects, the input sequence is a sequence of tokens (e.g., tensors) representing or corresponding to input to a machine learning model. As discussed above, the input sequence may be accessed for the purpose of generating attention output (e.g., applying a self-attention mechanism), such as using a transformer-based model.

At block 310, the machine learning system selects a token from the sequence. Generally, the machine learning system may use a variety of techniques to select the token. In some aspects, the machine learning system selects the tokens sequentially according to the tokens' order in the sequence.

At block 315, the machine learning system determines a token window for the selected token. That is, the machine learning system determines the set of token(s) that are included in the analysis window for generating attention for the selected token. In some aspects, as discussed above, the token window may include zero or more influential tokens and zero or more recent tokens. In some aspects, the token window includes the selected token itself. In some aspects, as discussed above, the token window includes the selected token, any influential tokens that are prior to the selected token in the sequence, and a set of zero or more recent tokens that are prior to the selected token (where the number of recent tokens varies based in part on the window size). In some aspects, the window of tokens does not include any subsequent tokens (e.g., tokens that occur after the selected token in the ordered sequence). In some aspects, the number of recent tokens may corresponds to the window size minus the number of influential tokens used and/or minus the given token (e.g., R=W−I−1 where R is the number of recent tokens, W is the window size and/is the number of recent tokens).

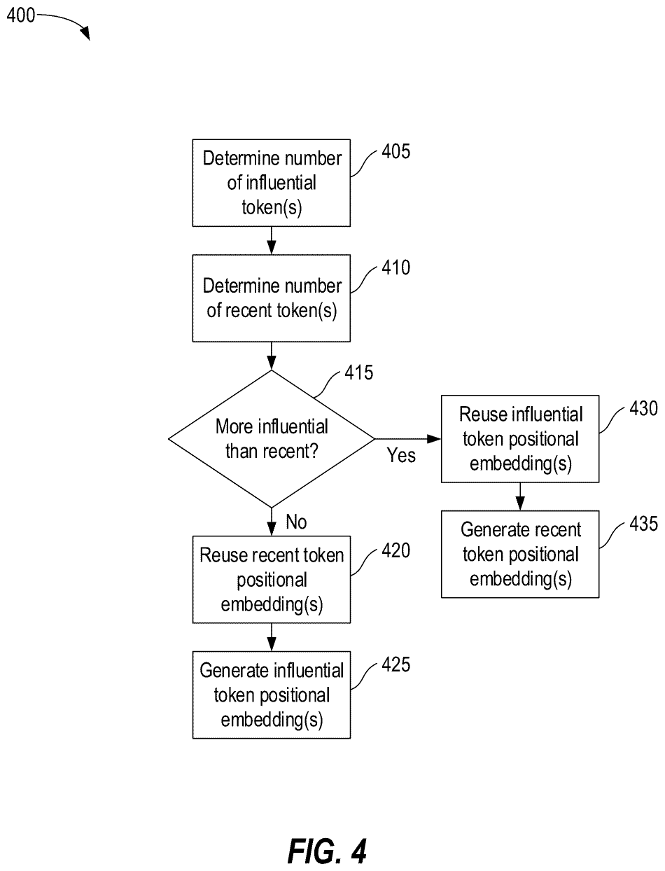

At block 320, the machine learning system determines to reuse one or more previously generated PEs for one or more tokens in the window, as discussed above. At block 325, the machine learning system generates one or more new PEs for one or more tokens in the window, as discussed above. For example, at block 325, the machine learning system may generate a PE for the selected token, as well as one or more other tokens from either the set of influential tokens or the set of recent tokens, as discussed above. One example method for determining which PEs to reuse and which to regenerate is discussed in more detail below with reference to FIG. 4.

At block 330, the machine learning system generates attention output for the selected token based at least in part on the reused PEs (accessed at block 320) and the newly generated PEs (generated at block 325), as discussed above. For example, as discussed above, the PEs may be used to encode the relative positions of the other tokens in the window, allowing the other tokens' values to be used to generate an attention value for the selected token.

At block 335, the machine learning system determines whether there is at least one additional token remaining in the sequence. If so, the method 300 returns to block 310. If not, the method 300 continues to block 340.

At block 340, the machine learning system generates model output (e.g., the model output 145 of FIG. 1) based on the attention outputs generated for each token in the sequence. For example, as discussed above, the machine learning system may process the attention data using one or more operations such as feedforward operations, activation operations, and the like. This model output may then be provided or used for a variety of purposes depending on the particular implementation. Although a single attention operation is depicted for conceptual clarity, in some aspects, the machine learning system may use any number of such attention operations at any stage of the data processing.

### Example Method for Improved Positional Embedding Generation for Machine Learning Models

FIG. 4 is a flow diagram depicting an example method 400 for improved positional embedding generation for machine learning models, according to some aspects of the present disclosure. In some aspects, the method 400 is performed by a machine learning system, such as the machine learning system 110 of FIG. 1 and/or the machine learning system discussed above with reference to FIGS. 2-3. In some aspects, the method 400 provides additional detail for blocks 320 and 325 of FIG. 3.

At block 405, the machine learning system determines the number of influential tokens in the token window. That is, the machine learning system may determine the number of influential tokens defined as a hyperparameter and/or the number of influential tokens that have already been processed.

At block 410, the machine learning system determines the number of recent tokens in the token window. That is, the machine learning system may determine the number of tokens, excluding influential tokens, which are included in the window. In some aspects, as discussed above, the selected token itself may be included as a recent token.

At block 415, the machine learning system determines whether there are more influential tokens in the window than recent tokens in the window (e.g., whether the size of the set of influential tokens is greater than the size of the set of recent tokens). If not, the method 400 continues to block 420, where the machine learning system determines to reuse the PE(s) that were previously generated for the recent token(s) in the window. At block 425, the machine learning system generates new PE(s) for the influential token(s). For example, blocks 420 and 425 may correspond to the workflow 200A of FIG. 2A.

Returning to block 415, if the machine learning system determines that there are more influential tokens in the window than recent tokens in the window, the method 400 continues to block 430. At block 430, the machine learning system determines to reuse the PE(s) that were previously generated for the influential token(s). At block 435, the machine learning system generates new PE(s) for the recent token(s) in the window. For example, blocks 430 and 435 may correspond to the workflow 200B of FIG. 2B.

In this way, by dynamically or selectively reusing previous PEs, the machine learning system can substantially reduce the computational complexity of generating output using the machine learning model.

### Example Method for Positional Embedding Generation

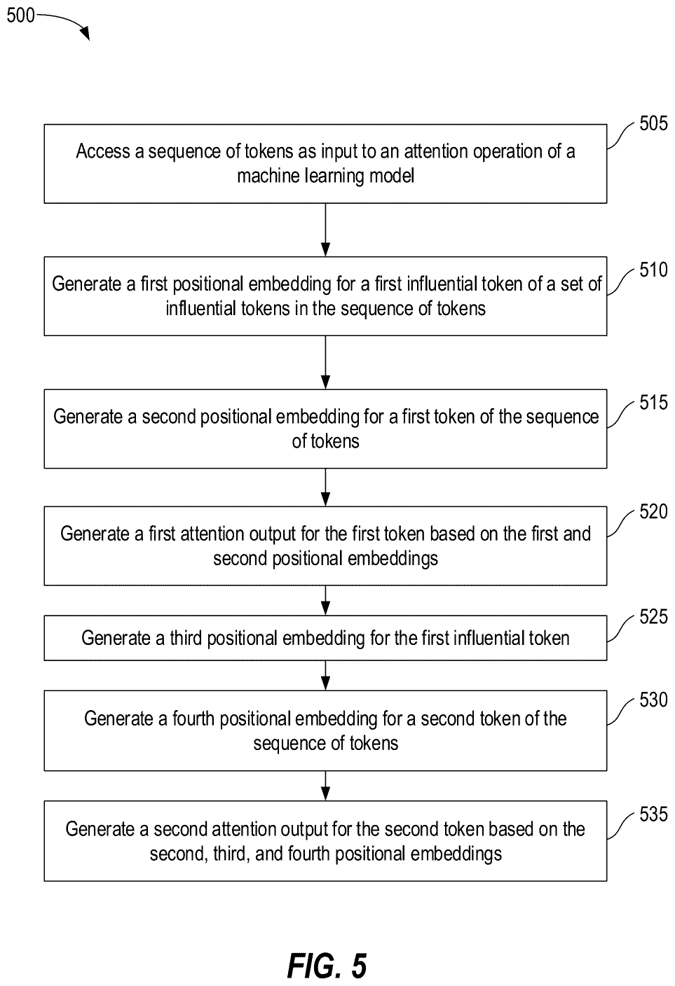

FIG. 5 is a flow diagram depicting an example method 500 for positional embedding generation, according to some aspects of the present disclosure. In some aspects, the method 500 is performed by a machine learning system, such as the machine learning system 110 of FIG. 1 and/or the machine learning system discussed above with reference to FIGS. 2-4.

At block 505, a sequence of tokens is accessed as input to an attention operation of a machine learning model.

At block 510, a first positional embedding for a first influential token of a set of influential tokens in the sequence of tokens is generated.

At block 515, a second positional embedding for a first token of the sequence of tokens is generated.

At block 520, a first attention output for the first token is generated based on the first and second positional embeddings.

At block 525, a third positional embedding for the first influential token is generated.

At block 530, a fourth positional embedding for a second token of the sequence of tokens is generated.

At block 535, a second attention output is generated for the second token based on the second, third, and fourth positional embeddings.

In some aspects, generating the second attention output comprises storing and reusing the second positional embedding that was generated while generating the first attention output.

In some aspects, generating the second attention output comprises reusing positional embeddings generated for each recent token of a set of recent tokens, wherein the set of recent tokens corresponds to the first window of tokens without the set of influential tokens or the second token.

In some aspects, generating the first attention output further comprises generating a respective positional embedding for each respective influential token of the set of influential tokens.

In some aspects, the set of influential tokens is defined as a static number of tokens at a beginning of the sequence of tokens, and the static number of tokens is a hyperparameter of the machine learning model.

In some aspects, the first window of tokens comprises: the set of influential tokens, the first token, and a set of recent tokens relative to the first token, wherein a size of the set of recent tokens is determined based on a size of the first window of tokens and the static number of tokens, wherein the size of the first window of tokens is a hyperparameter of the machine learning model.

In some aspects, the method 500 further includes generating, for each respective token of the sequence of tokens, a respective attention output based on generating a respective positional embedding for the first influential token.

In some aspects, the method 500 further includes generating an output of the machine learning model based on the first and second attention outputs.

In some aspects, the machine learning model comprises a large language model (LLM).

In some aspects, the method 500 further includes generating, for a third token of the sequence of tokens, a third attention output based on a third window of tokens relative to the third token, comprising: generating a fifth positional embedding for the third token, in response to determining that a size of the set of influential tokens is greater than a size of a set of recent tokens in the third window, generating a sixth positional embedding for a recent token in the set of recent tokens, and generating the third attention output based on the fifth positional embedding, the sixth positional embedding, and a previously generated positional embedding for the first influential token.

### Example Processing System for Machine Learning

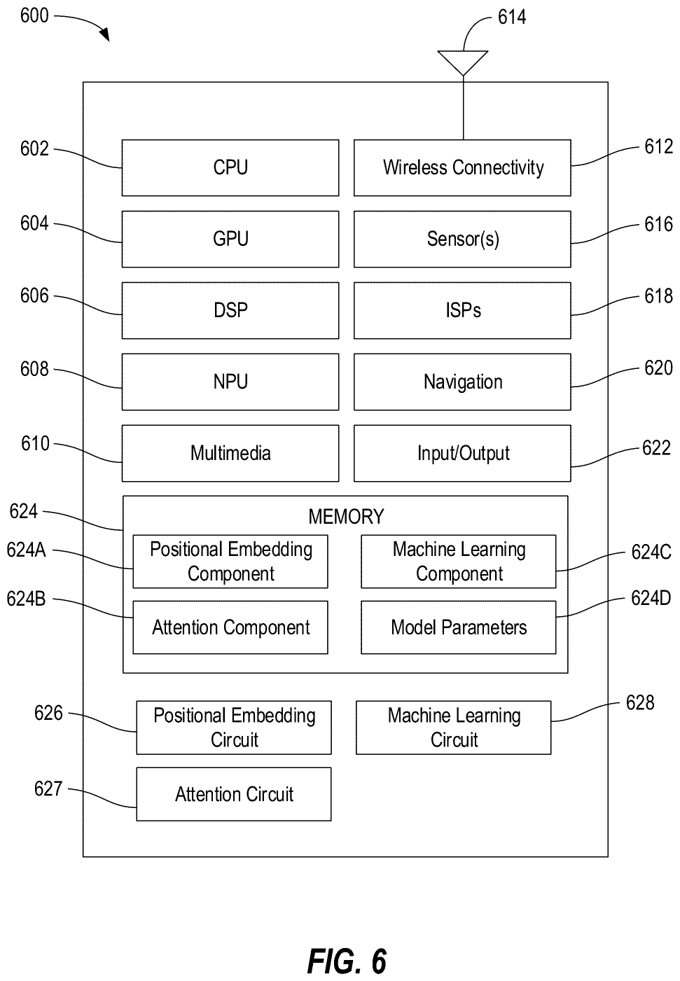

FIG. 6 depicts an example processing system 600 configured to perform various aspects of the present disclosure, including, for example, the techniques and methods described with respect to FIGS. 1-5. In some aspects, the processing system 600 may correspond to a machine learning system. For example, the processing system 600 may correspond to the machine learning system 110 of FIG. 1, and/or the machine learning system discussed above with reference to FIGS. 2-5. Although depicted as a single system for conceptual clarity, in some aspects, as discussed above, the components described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of a memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a positional embedding component 624A, an attention component 624B, and a machine learning component 624C. Although not depicted in the illustrated example, the memory 624 may also include other components, such as an inferencing or generation component to manage the generation of output predictions using trained machine learning models, a training component used to train or update the machine learning model(s), and the like. Though depicted as discrete components for conceptual clarity in FIG. 6, the illustrated components (and others not depicted) may be collectively or individually implemented in various aspects.

As illustrated, the memory 624 also includes a set of model parameters 624D (e.g., parameters of one or more machine learning models, such as weights and/or biases, used to generate model output). For example, as discussed above, the model parameters 624D may include learned parameters for an attention-based machine learning model (e.g., a model that uses transformers to perform self-attention, such as an LLM). Although not depicted in the illustrated example, the memory 624 may also include other data such as training data.

The processing system 600 further comprises a positional embedding circuit 626, an attention circuit 627, and a machine learning circuit 628. The depicted circuits, and others not depicted (such as an inferencing circuit), may be configured to perform various aspects of the techniques described herein.

The positional embedding component 624A and/or the positional embedding circuit 626 (which may correspond to the positional embedding component 130 of FIG. 1) may be used to selectively generate and reuse PEs while applying attention mechanisms, as discussed above. For example, the positional embedding component 624A and/or the positional embedding circuit 626 may selectively generate new PEs for some tokens in the window, while determining to reuse previously generated PEs for other tokens in the window.

The attention component 624B and/or the attention circuit 627 (which may correspond to the attention component 135 of FIG. 1) may be used to generate attention output for each given token based at least in part on PEs of tokens in the given window, as discussed above. For example, the attention component 624B and/or the attention circuit 627 may use QKV attention mechanisms to compute the attention value for each token.

The machine learning component 624C and/or the machine learning circuit 628 (which may correspond to the operations 115A and/or 115B of FIG. 1) may be used to perform various machine learning operations other than attention operations, as discussed above. For example, the machine learning component 624C and/or the machine learning circuit 628 may apply feedforward operations, activation functions, and the like.

Though depicted as separate components and circuits for clarity in FIG. 6, the positional embedding circuit 626, the attention circuit 627, and the machine learning circuit 628 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, aspects of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 maybe distributed between multiple devices.

### Example Clauses

Implementation examples are described in the following numbered clauses:
Clause 1: A method, comprising: accessing a sequence of tokens as input to an attention operation of a machine learning model; generating, for a first token of the sequence of tokens, a first attention output based on a first window of tokens relative to the first token, comprising: generating a first positional embedding for a first influential token of a set of influential tokens in the sequence of tokens; generating a second positional embedding for the first token; and generating the first attention output based on the first and second positional embeddings; and generating, for a second token of the sequence of tokens, a second attention output based on a second window of tokens relative to the second token, wherein the second window of tokens includes the first token, comprising: generating a third positional embedding for the first influential token; generating a fourth positional embedding for the second token; and generating the second attention output based on the second, third, and fourth positional embeddings.
Clause 2: A method according to Clause 1, wherein generating the second attention output comprises storing and reusing the second positional embedding that was generated while generating the first attention output.
Clause 3: A method according to any of Clauses 1-2, wherein generating the second attention output comprises reusing positional embeddings generated for each recent token of a set of recent tokens, wherein the set of recent tokens corresponds to the first window of tokens without the set of influential tokens or the second token.
Clause 4: A method according to any of Clauses 1-3, wherein generating the first attention output further comprises generating a respective positional embedding for each respective influential token of the set of influential tokens.
Clause 5: A method according to any of Clauses 1-4, wherein the set of influential tokens is defined as a static number of tokens at a beginning of the sequence of tokens, and the static number of tokens is a hyperparameter of the machine learning model.
Clause 6: A method according to Clause 5, wherein the first window of tokens comprises: the set of influential tokens, the first token, and a set of recent tokens relative to the first token, wherein a size of the set of recent tokens is determined based on a size of the first window of tokens and the static number of tokens, wherein the size of the first window of tokens is a hyperparameter of the machine learning model.
Clause 7: A method according to any of Clauses 1-6, further comprising generating, for each respective token of the sequence of tokens, a respective attention output based on generating a respective positional embedding for the first influential token.
Clause 8: A method according to any of Clauses 1-7, further comprising generating an output of the machine learning model based on the first and second attention outputs.
Clause 9: A method according to any of Clauses 1-8, wherein the machine learning model comprises a large language model (LLM).
Clause 10: A method according to any of Clauses 1-9, further comprising: generating, for a third token of the sequence of tokens, a third attention output based on a third window of tokens relative to the third token, comprising: generating a fifth positional embedding for the third token; in response to determining that a size of the set of influential tokens is greater than a size of a set of recent tokens in the third window, generating a sixth positional embedding for a recent token in the set of recent tokens; and generating the third attention output based on the fifth positional embedding, the sixth positional embedding, and a previously generated positional embedding for the first influential token.
Clause 11: A processing system comprising: a memory comprising computer-executable instructions; and one or more processors configured to execute the computer-executable instructions and cause the processing system to perform a method in accordance with any of Clauses 1-10.
Clause 12: A processing system comprising means for performing a method in accordance with any of Clauses 1-10.
Clause 13: A non-transitory computer-readable medium comprising computer-executable instructions that, when executed by one or more processors of a processing system, cause the processing system to perform a method in accordance with any of Clauses 1-10.
Clause 14: A computer program product embodied on a computer-readable storage medium comprising code for performing a method in accordance with any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a−b, a−c, b−c, and a−b−c, as well as any combination with multiples of the same element (e.g., a−a, a−a−a, a−a−b, a−a−c, a−b−b, a−c−c, b−b, b−b−b, b−b−c, c−c, and c−c−c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning comprising:
one or more memories comprising processor-executable instructions; and
one or more processors configured to execute the processor-executable instructions and cause the processing system to:
access a sequence of tokens as input to an attention operation of a machine learning model;
generate, for a first token of the sequence of tokens, a first attention output based on a first window of tokens relative to the first token, wherein, to generate the first attention output, the one or more processors are configured to execute the processor-executable instructions and cause the processing system to:
generate a first positional embedding for a first influential token of a set of influential tokens in the sequence of tokens;
generate a second positional embedding for the first token; and
generate the first attention output based on the first and second positional embeddings; and
generate, for a second token of the sequence of tokens, a second attention output based on a second window of tokens relative to the second token, wherein the second window of tokens includes the first token, wherein, to generate the second attention output, the one or more processors are configured to execute the processor-executable instructions and cause the processing system to:
generate a third positional embedding for the first influential token;
generate a fourth positional embedding for the second token; and
generate the second attention output based on the second, third,
and fourth positional embeddings.

2. The processing system of claim 1, wherein, to generate the second attention output, the one or more processors are configured to execute the processor-executable instructions and cause the processing system to store and reuse the second positional embedding that was generated while generating the first attention output.

3. The processing system of claim 1, wherein, to generate the second attention output, the one or more processors are configured to execute the processor-executable instructions and cause the processing system to reuse positional embeddings generated for each recent token of a set of recent tokens, wherein the set of recent tokens corresponds to the first window of tokens without the set of influential tokens or the second token.

4. The processing system of claim 1, wherein, to generate the first attention output, the one or more processors are configured to execute the processor-executable instructions and cause the processing system to generate a respective positional embedding for each respective influential token of the set of influential tokens.

5. The processing system of claim 1, wherein:
the set of influential tokens is defined as a static number of tokens at a beginning of the sequence of tokens, and
the static number of tokens is a hyperparameter of the machine learning model.

6. The processing system of claim 5, wherein the first window of tokens comprises:
the set of influential tokens,
the first token, and
a set of recent tokens relative to the first token, wherein a size of the set of recent tokens is determined based on a size of the first window of tokens and the static number of tokens, wherein the size of the first window of tokens is a hyperparameter of the machine learning model.

7. The processing system of claim 1, wherein the one or more processors are configured to execute the processor-executable instructions and cause the processing system to generate, for each respective token of the sequence of tokens, a respective attention output based on generating a respective positional embedding for the first influential token.

8. The processing system of claim 1, wherein the one or more processors are configured to execute the processor-executable instructions and cause the processing system to generate an output of the machine learning model based on the first and second attention outputs.

9. The processing system of claim 1, wherein the machine learning model comprises a large language model (LLM).

10. The processing system of claim 1, wherein the one or more processors are configured to execute the processor-executable instructions and cause the processing system to:
generate, for a third token of the sequence of tokens, a third attention output based on a third window of tokens relative to the third token, wherein, to generate the third attention output, the one or more processors are configured to execute the processor-executable instructions and cause the processing system to:
generate a fifth positional embedding for the third token;
in response to determining that a size of the set of influential tokens is greater than a size of a set of recent tokens in the third window, generate a sixth positional embedding for a recent token in the set of recent tokens; and
generate the third attention output based on the fifth positional embedding, the sixth positional embedding, and a previously generated positional embedding for the first influential token.

11. A processor-implemented method for generating output using machine learning, comprising:
accessing a sequence of tokens as input to an attention operation of a machine learning model;
generating, for a first token of the sequence of tokens, a first attention output based on a first window of tokens relative to the first token, comprising:
generating a first positional embedding for a first influential token of a set of influential tokens in the sequence of tokens;
generating a second positional embedding for the first token; and
generating the first attention output based on the first and second positional embeddings; and
generating, for a second token of the sequence of tokens, a second attention output based on a second window of tokens relative to the second token, wherein the second window of tokens includes the first token, comprising:
generating a third positional embedding for the first influential token;
generating a fourth positional embedding for the second token; and
generating the second attention output based on the second, third, and fourth positional embeddings.

12. The processor-implemented method of claim 11, wherein generating the second attention output comprises storing and reusing the second positional embedding that was generated while generating the first attention output.

13. The processor-implemented method of claim 11, wherein generating the second attention output comprises reusing positional embeddings generated for each recent token of a set of recent tokens, wherein the set of recent tokens corresponds to the first window of tokens without the set of influential tokens or the second token.

14. The processor-implemented method of claim 11, wherein generating the first attention output further comprises generating a respective positional embedding for each respective influential token of the set of influential tokens.

15. The processor-implemented method of claim 11, wherein:
the set of influential tokens is defined as a static number of tokens at a beginning of the sequence of tokens, and
the static number of tokens is a hyperparameter of the machine learning model.

16. The processor-implemented method of claim 15, wherein the first window of tokens comprises:
the set of influential tokens,
the first token, and
a set of recent tokens relative to the first token, wherein a size of the set of recent tokens is determined based on a size of the first window of tokens and the static number of tokens, wherein the size of the first window of tokens is a hyperparameter of the machine learning model.

17. The processor-implemented method of claim 11, further comprising generating, for each respective token of the sequence of tokens, a respective attention output based on generating a respective positional embedding for the first influential token.

18. The processor-implemented method of claim 11, further comprising generating an output of the machine learning model based on the first and second attention outputs.

19. The processor-implemented method of claim 11, further comprising:
generating, for a third token of the sequence of tokens, a third attention output based on a third window of tokens relative to the third token, comprising:
generating a fifth positional embedding for the third token;
in response to determining that a size of the set of influential tokens is greater than a size of a set of recent tokens in the third window, generating a sixth positional embedding for a recent token in the set of recent tokens; and
generating the third attention output based on the fifth positional embedding, the sixth positional embedding, and a previously generated positional embedding for the first influential token.

20. A processing system for machine learning, comprising:
means for accessing a sequence of tokens as input to an attention operation of a machine learning model;
means for generating, for a first token of the sequence of tokens, a first attention output based on a first window of tokens relative to the first token, comprising:
means for generating a first positional embedding for a first influential token of a set of influential tokens in the sequence of tokens;
means for generating a second positional embedding for the first token; and
means for generating the first attention output based on the first and second positional embeddings; and
means for generating, for a second token of the sequence of tokens, a second attention output based on a second window of tokens relative to the second token, wherein the second window of tokens includes the first token, comprising:
means for generating a third positional embedding for the first influential token;
means for generating a fourth positional embedding for the second token; and
means for generating the second attention output based on the second, third, and fourth positional embeddings.
